(19) United States
(12) Patent Application Publication
(10) Pub. No.: US 2011/0260976 A1
(43) Pub. Date: Oct. 27, 2011

(54) TACTILE OVERLAY FOR VIRTUAL KEYBOARD

(75) Inventors: Glen Larsen, Issaquah, WA (US); Nigel Keam, Redmond, WA (US); Steven Bathiche, Kirkland, WA (US)

(73) Assignee: MICROSOFT CORPORATION, Redmond, WA (US)

(21) Appl. No.: 12/764,807

(22) Filed: Apr. 21, 2010

(51) Int. Cl. G06F 3/02

(52) U.S. Cl. 345/168

(57) ABSTRACT

The present disclosure provides for a computing system having virtual keyboard functionality that can be selectively enhanced through use of a tactile keyboard overlay. The tactile keyboard overlay includes a plurality of depressible key portions, and is placed onto an operative surface of a touch interactive display. The computing system configures the virtual keyboard functionality, so that each of the depressible key portions is operable to produce a touch input on the touch interactive display that causes performance of a corresponding input operation. The virtual keyboard functionality is dynamically and automatically located on the touch interactive display based on user placement of the tactile keyboard overlay.

### BACKGROUND

Computing devices are increasingly being equipped with touch interactive displays having virtual keyboard functionality. Typically, a virtual keyboard will include a number of keys that are displayed on the touch interactive display. When any one of the keys is touched, for example by a user's finger, a corresponding input operation is performed, such as entry of a letter, number or other symbol. This type of virtual keyboard can provide many advantages in a wide variety of settings. In some cases, however, they are less desirable from a pure input standpoint. Specifically, users often find that the tactile feedback of a physical keyboard provides a more responsive and agreeable typing experience.

### SUMMARY

Accordingly, the description herein provides for a computing system having virtual keyboard functionality that can be selectively enhanced through use of a tactile keyboard overlay. The tactile keyboard overlay is configured to be placed on an operative surface of a touch interactive display, and includes a plurality of depressible key portions. The system configures the virtual keyboard functionality so that each of the depressible key portions is operable to produce a touch input on the touch interactive display that causes performance of a corresponding input operation. Moreover, the system dynamically and automatically locates the virtual keyboard functionality relative to the operative surface of the touch interactive display, so that a user can place the tactile keyboard overlay in any of a plurality of positions on the operative surface of the touch interactive display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1 and 2 are schematic depictions of exemplary computing systems having virtual keyboard functionality that may be selectively enhanced through use of a tactile keyboard overlay.

FIGS. 3 and 4 depict an example of a virtual keyboard being dynamically configured in response to user placement of a tactile keyboard overlay onto a touch interactive display.

FIG. 5 depicts an exemplary depressible key portion of an embodiment of a tactile keyboard overlay.

FIG. 6 depicts an example of a force-displacement characteristic for a keyboard overlay configured to provide tactile user feedback.

FIGS. 7 and 8 are side views of an embodiment of a tactile keyboard overlay, with FIG. 8 providing illustration of one depressible key portion being depressed toward a touch interactive display in order to cause a touch input and corresponding input operation.

FIG. 9 is a bottom view of an embodiment of a tactile keyboard overlay, showing overlay tags that may be sensed in order to facilitate performance of configuration tasks for a virtual keyboard associated with the overlay.

FIG. 10 is a bottom view of another embodiment of a tactile keyboard overlay, showing individual interactive tags that may be employed with individual depressible key portions of the overlay.

FIG. 11 is a bottom view of a further embodiment of a depressible key portion of a tactile keyboard overlay.

FIGS. 12-14 depict exemplary methods for configuring a virtual keyboard to work in conjunction with a tactile keyboard overlay.

### DETAILED DESCRIPTION

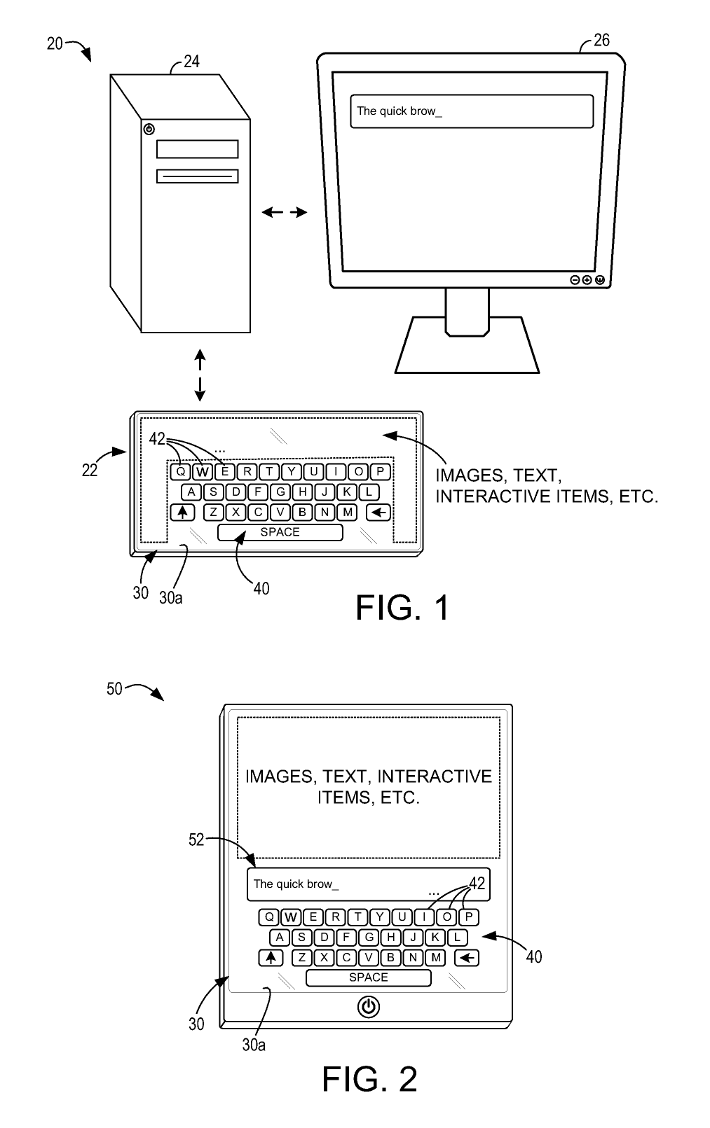

FIGS. 1 and 2 show examples of computing devices having virtual keyboard functionality. In both examples, a virtual keyboard is implemented in connection with a touch interactive display. The virtual keyboard is programmable and may be disposed in any desired position (e.g., location and/or orientation) on the operative surface of the touch interactive display. The virtual keyboard may include any number of keys, in any practicable layout, and the individual keys may be programmed or otherwise configured to perform any desirable input operation.

As will be described in various examples, a tactile keyboard overlay may be used to selectively enhance the operation of a virtual keyboard. The tactile keyboard overlay includes a plurality of depressible key portions that can provide tactile feedback, similar to that provided by domeswitch keyboards and other types of mechanical/physical keyboards. In addition, the described overlays and supporting software can be configured to enable automatic configuration of virtual keyboard functionality. The automatic configuration enables the overlay to work automatically when the user places it on a touch interactive display, regardless of the particular location and orientation in which it is positioned.

In FIG. 1, touch interactivity for computing system 20 is provided via tablet peripheral 22, which is operatively coupled with a component enclosure 24 (containing, e.g., storage/memory components, a processor, bus, network adapter, etc.). A display monitor 26 is also operatively coupled with the component enclosure, to provide the primary display for the system, which may be supplemented by the output capability of tablet peripheral 22. Tablet peripheral 22 includes a touch interactive display 30 having an operative surface 30a. As indicated, a virtual keyboard 40 is located on the operative surface of the touch interactive display, and includes a plurality of keys 42. As indicated, other regions of the touch interactive display may include images, text, other touch interactive items, and the like. As will be described in more detail below, the storage/memory components of computing system 20 typically include instructions executable by the processor to carry out various tasks in connection with the functionality of virtual keyboard 40.

In FIG. 2, touch interactive display 30 is implemented in the context of portable computing device 50 having a tablet- or pad-type form factor. As in the prior example, virtual keyboard 40 and its keys 42 are provided on operative surface 30a of the touch interactive display, and other regions of the display may be used for other content (images, text, interactive items, etc.). Device 50 typically also includes memory/storage and processor components to carry out various tasks, including functions associated with the configuration and use of the virtual keyboard 40. Since device 50 is a self-contained unit without a separate primary display, the text output produced by virtual keyboard 40 typically is displayed on the touch interactive display, as indicated at 52. It should be understood that FIGS. 1 and 2 are but examples, and that the tactile keyboard overlay described herein may be used in a variety of other virtual keyboard environments.

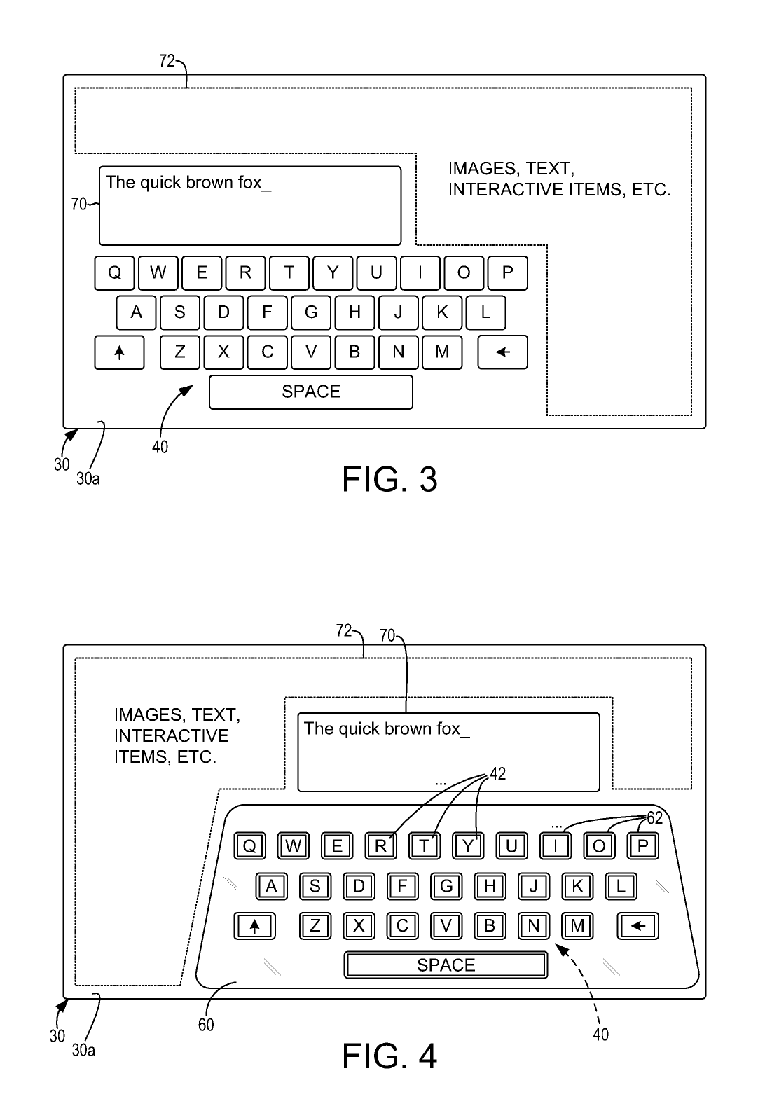

Turning now to FIGS. 3 and 4, the figures depict touch interactive display 30 in two different states. In FIG. 3, virtual keyboard 40 is displayed in a lower left-hand portion of the operative surface 30a of touch interactive display 30. In FIG. 4, a user has placed tactile keyboard overlay 60 in the lower right-hand portion of the operative surface 30a. In response to this placement, supporting software (e.g., instructions executed by a processor on the devices shown in FIGS. 1 and 2) has automatically configured the interactivity of touch interactive display 30 to re-locate the virtual keyboard (i.e., relocate it from the position shown in FIG. 3), so that the overlay and virtual keyboard can work in the new location without further user intervention. Use of the overlay can provide many advantages, in that it is selective and can be used in any desired location when tactile feedback is desired by the user. The overlay provides tactile feedback to improve the input functionality while retaining the programmability, flexibility and many other benefits of the virtual keyboard. When not needed or desired, the overlay may be removed and the space that was covered by the overlay can again be used for non-overlay input or other purposes.

Tactile keyboard overlay 60 may take various configurations and be formed from a variety of materials. In some embodiments, the overlay is a unitary, flexible piece of material that may be rolled up or folded when not in use, such as during shipping or storage. When deployed, however, the overlay is laid out flat on top of a touch interactive device, and automated configuration tasks are performed to dynamically configure and position the virtual keyboard underneath the overlay. Regardless of its particular configuration, the overlay typically includes a plurality of depressible key portions 62 that are depressed toward the virtual keyboard 40 to activate keys 42 via touch interaction.

As indicated above, the overlay and its supporting software may be configured to provide automatic configuration, so that the overlay works without the user having to do anything other than place the overlay in a desired position. As a result, each depressible key portion is operable to cause a touch interaction with the underlying device that produces a corresponding input operation—e.g., entry of a letter, number, symbol, etc.

Part of the automatic configuration may include dynamically locating the virtual keyboard functionality in response to user placement of the tactile keyboard overlay. In FIG. 4, the overlay has been placed in the lower right-hand corner of the display. As a result, the virtual keyboard has been automatically positioned underneath the overlay. In conjunction with this dynamic locating of the virtual keyboard functionality, the supporting software may also be configured to move other items. For example, placement of the overlay in FIG. 4 has also resulted in a rearrangement of text box 70 and a region 72 containing other content. Automatic configuration may also include causing the virtual keyboard to be displayed in a particular location corresponding to user placement of the overlay. In particular, in addition to placement of the appropriate touch interactivity underneath overlay 60, the individual displays for each key 42 have been repositioned so that they are visible through the depressible key portions of the overlay. Typically, the visual display for each key location is a symbol or some other indicia relating to the function of the corresponding key, though other visual output may be provided as desired.

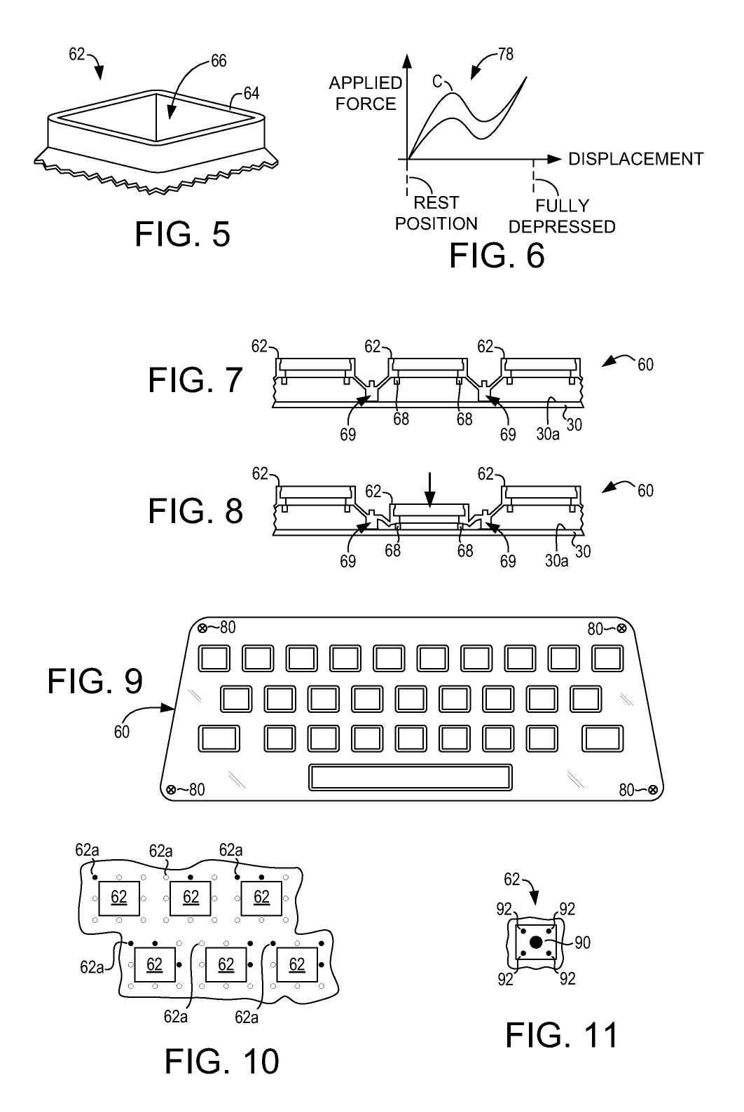

Referring now to FIG. 5, the figure shows an example of a depressible key portion 62 that may be employed in connection with the tactile keyboard overlays discussed herein. Depressible key portion 62 may include a sidewall 64 shaped to conform to the shape of the underlying keys of a virtual keyboard (square/rectangular in the present example). In the depicted example, a central area 66 of the key portion is see-through to enable viewing of an underlying key of the virtual keyboard. In some embodiments, central area 66 is hollow. In others, a central portion of the key may be formed from a transparent material (e.g., a lens) to permit viewing of the underlying display.

Typically, the depressible key portion is configured with a force-displacement characteristic that provides tactile feedback to the user. An example of such a characteristic is shown in FIG. 6 at 78. The upper portion of the characteristics corresponds to the key being depressed; the lower corresponds to release of the key. As seen in the characteristic, as the key is displaced from a rest position towards being fully depressed, a relatively higher amount of force is needed to move the key through the initial part of its range. At some point, the depressible key portion collapses, as indicated by the corner C in the characteristic. This collapse is tangibly felt by the user, and provides affirming feedback that the key has been actuated.

FIGS. 7 and 8 are partial side views of tactile keyboard overlay 60, including a group of three depressible key portions 62. In FIG. 7, the middle key portion 62 is shown in a rest position, in which its underside is spaced away from operative surface 30a of touch interactive display 30. In FIG. 8, the middle key portion 62 has been depressed into its fully-depressed position, in which its underside is sensed by touch interactive display 30 to create a touch input. As specifically indicated on the middle key portion 62 in FIG. 8, the underside of each depressible key portion may be provided with structures (e.g., posts 68) that are specifically designed to cause touch inputs at the surface of touch interactive device 30.

FIGS. 7 and 8 also provide illustration of an overlay having a unitary construction, for example using a flexible plastic or rubbery material. Such a construction may be achieved through a molding process, and may include intervening portions 69 that move or flex to facilitate the tactile collapse described with reference to FIG. 6.

FIG. 9 provides a further depiction of tactile keyboard overlay 60, and illustrates exemplary features that may be employed on the underside of the overlay to facilitate automatic configuration of the virtual keyboard functionality. As indicated above, in some examples, automatic configuration can include dynamically locating the virtual keyboard functionality on the touch interactive display in response to user placement of the overlay. This may include, for example, automatically determining a location for each of the overlay's depressible key portions, relative to the operative surface of the touch interactive display. Thus, a location can be determined on the touch interactive display corresponding to each of the depressible key portions. Then, when a touch input is detected at one of the locations, the input operation that corresponds to that location/depressible key portion is performed.

One exemplary method for determining the individual key locations on the touch interactive display is to first locate the overlay as a whole. This may be achieved through use of identifiers or locators provided on the underside of the overlay. Specifically, as indicated in FIG. 9, the underside of the overlay may be provided with overlay tags 80. The overlay tags are adapted to cause a touch interaction with a touch interactive display device when the overlay is laid in place. By detecting one or more of the tags, the touch interactive supporting software can determine the location and orientation of tactile keyboard overlay 60. In addition to providing positional information, the tags may be patterned, shaped or otherwise configured to identify the overlay and/or its characteristics—e.g., the tags might uniquely identify the particular key layout of the overlay. Then, by referring to pre-existing knowledge of the overlay (e.g., its key layout), the underlying virtual keyboard can be configured. Among other things, the particular locations of each depressible key portion and the corresponding touch location on the touch interactive display can be determined automatically in response to the detection and interpretation of tags 80.

FIG. 10 depicts a further method for automatically configuring virtual keyboard functionality associated with an overlay. Specifically, the figure is a depiction of the underside of a portion of a tactile keyboard overlay 60. In addition to or instead of overlay tags 80 (FIG. 9), each depressible key portion 62 is provided with its own key tag 62a (in the figure, reference number 62a and the term “key tag” refer collectively to the eight circles surrounding each square region). When the individual depressible key portion is actuated, the key tag interacts with the underlying touch interactive device to create a unique touch interaction. This touch interaction is interpreted so that the underlying software knows which key portion on the overlay was actuated. In other words, for example, a unique tag is associated with the upper leftmost key on the tactile keyboard overlay. When this key portion is depressed, the sensed touch has a unique shape or pattern that allows the software to identify the key portion, and therefore cause its associated input operation to be performed (e.g., entry of the letter “Q”).

In the example of FIG. 10, the key tags are implemented through a bitcode in which each key tag has eight post positions surrounding the central portion of the depressible key portion. Each depressible key portion has a unique post pattern which causes a unique sensed touch to occur when the key portion is depressed. In the schematic usage of FIG. 10, the presence of a post in one of the positions is indicated by a solid dot. If the position is empty (no post), then the position is indicated by an empty circle. Thus, if the upper left position were the least significant bit in an eight-bit representation, with bits increasing in significance in a clockwise direction around each depressible key portion, then the binary representation of each of the three tags on the upper row would be as follows: 00000001, 00000010, and 00000011. The binary representation of the three lower tags would be 00001011, 00001100, and 00001101.

FIG. 11 depicts an alternate implementation of a depressible key portion 62. In contrast to several of the earlier examples, the depressible key portion of FIG. 11 is opaque. Since the central portion of the key is not needed for through-key viewing of an underlying display device, various other options are available for the structures used to interact with the touch interactive device. In FIG. 11, for example, a larger central post 90 is employed in connection with additional posts 92 arrayed about the central post.

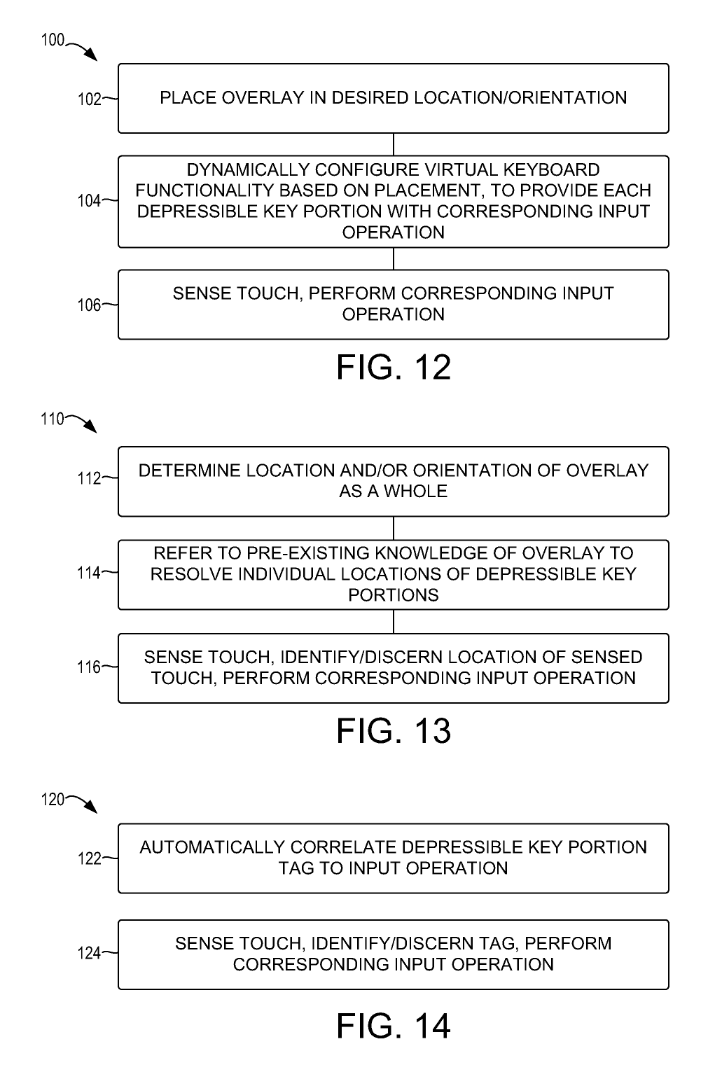

From the above, it should be understood that the present description also encompasses a method of using an overlay in connection with a virtual keyboard to selectively enhance input functionality. At 100, FIG. 12 provides an illustrative example of such a method. As indicated at 102, method 100 may include placement of a tactile keyboard overlay in a desired position. The ability to place the overlay in any desired position makes it desirable to have the configuration of the overlay occur automatically. Automatic configuration can allow the overlay to be used immediately, regardless of its location/orientation and without the user having to do anything other than place the overlay as desired.

Thus, at 104, the method may also include dynamically configuring the touch interactive display to provide virtual keyboard functionality underneath the tactile keyboard overlay. The dynamic configuration results in a corresponding input operation being established for each depressible key portion of the overlay. As a result, when a user depresses a given key portion on the overlay, the resulting interaction with the underlying display device (e.g., a touch interaction) causes the input operation corresponding to that key portion to be performed. This is shown, for example, at 106, where the method includes performing a corresponding input operation in response to sensing a touch (e.g., on a touch interactive display). Detection of a “key down” state and other touch or near-touch sensing may be performed in this and the other examples using any appropriate sensing technology, including optical, capacitive, resistive, and/or inductive technologies, to name but a few non-limiting examples.

The automated configuration described with reference to FIG. 12 and other examples may be performed in various ways. A first example of automatic configuration is denoted at 110 in FIG. 13. Generally, method 110 provides a method of determining a location for each of a plurality of depressible key portions on a tactile keyboard overlay that has been placed in a desired location/orientation over a touch interactive display. As shown at 112, the method may first include determining a location and/or orientation for the overlay as a whole. Then, at 114, the method includes referring to pre-existing knowledge of the overlay to resolve the individual locations of the overlay's depressible key portions. Typically, this involves establishing a location on the touch interactive display to correspond to each depressible key portion. The pre-existing knowledge may include information relating to the layout of the overlay, including, for example, the number, spacing, shape and/or arrangement of the key portions. Identification of the overlay and its location/orientation may be performed via detection of tags provided on the underside of the overlay, as described with reference to FIG. 9. At 116, the method may also include sensing a touch from the overlay, identifying and/or discerning a location of the touch, and then performing the corresponding input operation.

Another example of automatic configuration is shown at 120 in FIG. 14. Method 120 may include automatically correlating input operations with tags that are associated with individual depressible key portions of a tactile keyboard overlay, as shown at 122. Then, at 124, the method includes identifying or discerning the tag that is associated with a sensed touch, and then performing the corresponding input operation if a tag is detected.

The examples herein have been discussed primarily in the context of virtual keyboards provided on touch interactive displays. In this context, unless specifically not applicable, terms such as “touch” and “touch interactive” should be understood to include not only capacitance-based and other contact-type methods, but also implementations that employ close proximity or near-touch methods. For example, the described system and methods may be employed in connection with an optical or vision-based system (e.g., using a camera-type device), in which an interactive device provides a virtual keyboard that is responsive to the near-touch approach of objects such as a user's fingers and/or portions of a tactile keyboard overlay.

As previously indicated, the virtual keyboard operations discussed herein may be performed by executing computer code or other instructions with a processor, such as that described with reference to FIGS. 1 and 2. More generally, any type of logic subsystem may be employed. The executable instructions may be part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

As also indicated with respect to FIGS. 1 and 2, memory/storage components may be employed, for example to hold the instructions used to carry out virtual keyboard tasks. More generally, any practicable type of data-holding subsystem may be employed. For example, instructions and other data may be held via one or more physical devices configured to hold data and/or instructions executable by a processor. When methods and processes are implemented, the state of data-holding subsystem may be transformed (e.g., to hold different data). Removable media and/or built-in devices may be employed. Instructions and other data may be held on optical memory devices, semiconductor memory devices, and/or magnetic memory devices, among others. The specific system and devices that are employed may have one or more of the following characteristics: volatile, nonvolatile, dynamic, static, read/write, read-only, random access, sequential access, location addressable, file addressable, and content addressable. In some embodiments, processing and data-holding functionality may be integrated into one or more common devices, such as an application specific integrated circuit or a system on a chip.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing system with virtual keyboard functionality that can be tactilely enhanced through selective use of a tactile keyboard overlay, comprising:
a computing device having a touch interactive display;
a tactile keyboard overlay configured to be placed by a user on an operative surface of the touch interactive display, the tactile keyboard overlay including a plurality of depressible key portions; and
instructions stored on the computing device and executable by a processor of the computing device to configure virtual keyboard functionality on the touch interactive display for the tactile keyboard overlay, such that for each of the depressible key portions, a touch input at the touch interactive display caused by operation of the depressible key portion is interpreted to perform a corresponding input operation, the instructions being further configured to dynamically and automatically locate the virtual keyboard functionality in response to user placement of the tactile keyboard overlay in any of a plurality of positions on the operative surface of the touch interactive display.

2. The computing system of claim 1, where the instructions are configured to automatically determine, in response to user placement of the tactile keyboard overlay, a location on the operative surface of the touch interactive device corresponding to each of the plurality of depressible key portions.

3. The computing system of claim 2, where the instructions are configured to automatically determine the location on the operative surface corresponding to each of the plurality of depressible key portions by first determining a position of the tactile keyboard overlay as a whole, and then referring to pre-existing knowledge of a layout of the tactile keyboard overlay.

4. The computing system of claim 2, where said dynamic and automatic location of the virtual keyboard functionality in response to user placement of the tactile keyboard overlay includes causing the touch interactive display to display, for each of the plurality of depressible key portions, indicia that is visible through the depressible key portion.

5. The computing system of claim 1, where each of the plurality of depressible key portions has a unique interactive tag that is configured to be sensed by touch interactive display when the depressible key portion is depressed, and where the instructions are configured to perform the corresponding input operation in response to sensing of the unique interactive tag.

6. The computing system of claim 1, where each of the plurality of depressible key portions is at least partially see-through to enable viewing of an underlying portion of the touch interactive display.

7. The computing system of claim 6, where each of the plurality of depressible key portions has a hollow center to permit viewing of the underlying portion of the touch interactive display.

8. The computing system of claim 6, where each of the plurality of depressible key portions has a central portion formed from transparent material to permit viewing of the underlying portion of the touch interactive display.

9. A computing system with virtual keyboard functionality that can be tactilely enhanced through selective use of a tactile keyboard overlay, comprising:
a computing device having a touch interactive display with an operative surface;
a tactile keyboard overlay configured to be placed by a user on the operative surface of the touch interactive display in any of a plurality of positions, the tactile keyboard overlay including a plurality of depressible key portions; and
instructions stored on the computing device and executable by a processor of the computing device to:
automatically determine, based on placement of the tactile keyboard overlay, a location on the operative surface of the touch interactive display corresponding to each of the depressible key portions;
correlate, for each of the depressible key portions, an input operation corresponding to the depressible key portion; and
perform, upon sensing a touch input at the location on the operative surface determined for any one of the depressible key portions, the input operation corresponding to such depressible key portion.

10. The computing system of claim 9, where the instructions are further configured to cause the touch interactive display to display, at the location determined for each of the depressible key portions, indicia for the input operation corresponding to such depressible key portion.

11. The computing system of claim 9, where each of the plurality of depressible key portions is at least partially see-through to enable viewing of an underlying portion of the touch interactive display.

12. The computing system of claim 11, where each of the plurality of depressible key portions has a hollow center to permit viewing of the underlying portion of the touch interactive display.

13. The computing system of claim 11, where each of the plurality of depressible key portions has a central portion formed from transparent material to permit viewing of the underlying portion of the touch interactive display.

14. A method for providing a virtual keyboard with tactile enhancement, comprising:
placing a tactile keyboard overlay in any of a plurality of positions on an operative surface of a touch interactive display of a computing device, the tactile keyboard overlay having a plurality of depressible key portions; and
in response to placement of the tactile keyboard overlay, dynamically configuring the touch interactive display to provide virtual keyboard functionality underneath the tactile keyboard overlay, such that for each of the plurality of depressible key portions, physically depressing the depressible key portion produces a touch input at the touch interactive device which is interpreted to perform a corresponding input operation.

15. The method of claim 14, further comprising, in response to placement of the tactile keyboard overlay, determining a location on the operative surface of the touch interactive display corresponding to each of the plurality of depressible key portions.

16. The method of claim 15, further comprising, in response to sensing a touch input at the location on the operative surface determined for any one of the depressible key portions, performing the corresponding input operation for the depressible key portion.

17. The method of claim 15, further comprising, for each of said locations on the operative surface of the touch interactive display, displaying indicia associated with the depressible key portion corresponding to that location.

18. The method of claim 14, where determining a location on the operative surface for each of the plurality of depressible key portions includes first determining a position of the tactile keyboard overlay as a whole, and then referring to pre-existing knowledge of a layout of the tactile keyboard overlay.

19. The method of claim 18, where determining the position of the tactile keyboard overlay as a whole includes detecting a touch interaction between the operative surface of the touch interactive display and a plurality of overlay tags provided on an underside of the tactile keyboard overlay.

20. The method of claim 14, where each of the plurality of depressible key portions includes a unique interactive tag that is configured to interact with the operative surface of the touch interactive display when the depressible key portion is depressed, and where said automatic correlation of the input operation with the depressible key portion is based on the unique interactive tag.
